(19) United States
(12) Patent Application Publication
(10) Pub. No.: US 2022/0200763 A1
(43) Pub. Date: Jun. 23, 2022

(54) APPARATUS AND METHOD OPERABLE FOR MEDIUM ACCESS CONTROL PACKET DATA UNIT

(71) Applicant: GUANGDONG OPPO MOBILE TELECOMMUNICATIONS CORP., LTD., Dongguan (CN)

(72) Inventors: Xin You, Dongguan (CN); Cong Shi, Dongguang (CN); Wenhong Chen, Dongguang (CN); Zhihua Shi, Dongguang (CN)

(73) Assignee: GUANGDONG OPPO MOBILE TELECOMMUNICATIONS CORP., LTD., Dongguan (CN)

(21) Appl. No.: 17/690,279

(22) Filed: Mar. 9, 2022

Related U.S. Application Data
(63) Continuation of application No. PCT/CN2019/114484, filed on Oct. 30, 2019.

(51) Int. Cl. H04L 5/00

(52) U.S. Cl. CPC H04L 5/0053

(57) ABSTRACT

An apparatus and a method operable for medium access control packet data unit (MAC PDU), which can save signaling overhead and/or improve reliability, are provided. The method performed by a user equipment includes receiving a radio resource allocation from a network node and configuring a MAC PDU associated with the radio resource allocation, wherein the MAC PDU comprises one or more MAC subPDUs, each MAC subPDU comprises a MAC subheader and a MAC CE, wherein a PUCCH spatial relation activation/deactivation MAC CE is identified by the MAC PDU subheader with a logical channel identity (LCID) and includes following fields: a serving cell ID, a BWP ID, R, and at least one of one or multiple of PUCCH resource group (PRG) IDs and one or multiple of PUCCH spatial relation information (SRI) ID indexes, where the R field means a reserved bit.

### CROSS REFERENCE TO RELATED APPLICATIONS

This application is a continuation of International Application No. PCT/CN2019/114484, filed on Oct. 30, 2019. The entire disclosures of this application is incorporated herein by reference.

### BACKGROUND OF DISCLOSURE

### 1. Field of Disclosure

The present disclosure relates to the field of communication systems, and more particularly, to an apparatus and a method operable for medium access control packet data unit (MAC PDU).

### 2. Description of Related Art

Data are generally transmitted between a user equipment (UE) and a network node through a packet data convergence protocol (PDCP) layer, a radio link control (RLC) layer, a medium access control (MAC) layer, and a physical (PHY) layer, each of which processes the data differently. The PDCP layer generally functions to perform security-related operations, and header compression and decompression, etc. The RLC layer generally functions to segment the data, to concatenate the data segments, to deliver the data segments in sequence, to perform automatic repeat-request (ARQ) operations, etc. The MAC layer generally functions to schedule PHY-layer resources in an uplink or a downlink. The PHY layer generally packages a transport block, transmits the packet via an air interface.

Although wireless communication technology has been developed to long term evolution (LTE) based on wideband code division multiple access (WCDMA), demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

In addition, an existing physical uplink control channel (PUCCH) spatial relation activation/deactivation MAC control element (CE) has a large signaling overhead. There is a need to propose an apparatus and a method operable for medium access control packet data unit (MAC PDU), which can provide at least one of the following benefits: solving issues of the prior art, saving signaling overhead, providing better communication, or improving reliability.

### SUMMARY

An object of the present disclosure is to propose an apparatus and a method operable for medium access control packet data unit (MAC PDU), which can provide at least one of the following benefits: solving issues of the prior art, saving signaling overhead, providing better communication, or improving reliability.

In a first aspect of the present disclosure, a user equipment operable for medium access control packet data unit (MAC PDU) includes a memory, a transceiver, and a processor coupled to the memory and the transceiver. The processor is configured to control the transceiver to receive a radio resource allocation from a network node and configure a MAC PDU associated with the radio resource allocation, wherein the MAC PDU comprises one or more MAC subPDUs, each MAC subPDU comprises a MAC subheader, wherein a physical uplink control channel (PUCCH) spatial relation activation/deactivation medium access control (MAC) control element (CE) is identified by the MAC PDU subheader with a logical channel identity (LCID), the PUCCH spatial relation activation/deactivation MAC CE includes following fields: a serving cell ID, a bandwidth part (BWP) ID, R, and at least one of one or multiple of PUCCH resource group (PRG) IDs and one or multiple of PUCCH spatial relation information (SRI) ID indexes, where the R field means a reserved bit.

In a second aspect of the present disclosure, a method operable for medium access control packet data unit (MAC PDU) of a user equipment includes receiving a radio resource allocation from a network node and configuring a MAC PDU associated with the radio resource allocation, wherein the MAC PDU comprises one or more MAC subPDUs, each MAC subPDU comprises a MAC subheader, wherein a physical uplink control channel (PUCCH) spatial relation activation/deactivation medium access control (MAC) control element (CE) is identified by the MAC PDU subheader with a logical channel identity (LCID), the PUCCH spatial relation activation/deactivation MAC CE includes following fields: a serving cell ID, a bandwidth part (BWP) ID, R, and at least one of one or multiple of PUCCH resource group (PRG) IDs and one or multiple of PUCCH spatial relation information (SRI) ID indexes, where the R field means a reserved bit.

In a third aspect of the present disclosure, a network node operable for medium access control packet data unit (MAC PDU) includes a memory, a transceiver, and a processor coupled to the memory and the transceiver. The processor is configured to control the transceiver to transmit, to a user equipment, a radio resource allocation and be configured a MAC PDU associated with the radio resource allocation from the user equipment, wherein the MAC PDU comprises one or more MAC subPDUs, each MAC subPDU comprises a MAC subheader, wherein a physical uplink control channel (PUCCH) spatial relation activation/deactivation medium access control (MAC) control element (CE) is identified by the MAC PDU subheader with a logical channel identity (LCID), the PUCCH spatial relation activation/deactivation MAC CE includes following fields: a serving cell ID, a bandwidth part (BWP) ID, R, and at least one of one or multiple of PUCCH resource group (PRG) IDs and one or multiple of PUCCH spatial relation information (SRI) ID indexes, where the R field means a reserved bit.

In a fourth aspect of the present disclosure, a method operable for medium access control packet data unit (MAC PDU) of a network node includes transmitting, to a user equipment, a radio resource allocation and being configured a MAC PDU associated with the radio resource allocation from the user equipment, wherein the MAC PDU comprises one or more MAC subPDUs, each MAC subPDU comprises a MAC subheader, wherein a physical uplink control channel (PUCCH) spatial relation activation/deactivation medium access control (MAC) control element (CE) is identified by the MAC PDU subheader with a logical channel identity (LCID), the PUCCH spatial relation activation/deactivation MAC CE includes following fields: a serving cell ID, a bandwidth part (BWP) ID, R, and at least one of one or multiple of PUCCH resource group (PRG) IDs and one or multiple of PUCCH spatial relation information (SRI) ID indexes, where the R field means a reserved bit.

In a fifth aspect of the present disclosure, a user equipment operable for medium access control packet data unit (MAC PDU) includes a memory, a transceiver, and a processor coupled to the memory and the transceiver. The processor is configured to control the transceiver to receive a radio resource allocation from a network node and configure a MAC PDU associated with the radio resource allocation, wherein the MAC PDU comprises one or more MAC subPDUs, each MAC subPDU comprises a MAC subheader, wherein a transceiver control interface (TCI) state activation/deactivation for a UE-specific physical downlink shared channel (PDSCH) medium access control (MAC) control element (CE) is identified by the MAC PDU subheader with a logical channel identity (LCID), wherein the UE-specific PDSCH MAC CE has a variable size comprising following fields: a component carrier (CC) list ID, Ti, and R, where the Ti field indicates an activation/deactivation status of a TCI state with a TCI state ID, and the R field means a reserved bit.

In a sixth aspect of the present disclosure, a method operable for medium access control packet data unit (MAC PDU) of a user equipment includes receiving a radio resource allocation from a network node and configuring a MAC PDU associated with the radio resource allocation, wherein the MAC PDU comprises one or more MAC subPDUs, each MAC subPDU comprises a MAC subheader, wherein a transceiver control interface (TCI) state activation/deactivation for a UE-specific physical downlink shared channel (PDSCH) medium access control (MAC) control element (CE) is identified by the MAC PDU subheader with a logical channel identity (LCID), wherein the UE-specific PDSCH MAC CE has a variable size comprising following fields: a component carrier (CC) list ID, Ti, and R, where the Ti field indicates an activation/deactivation status of a TCI state with a TCI state ID, and the R field means a reserved bit.

In a seventh aspect of the present disclosure, a network node operable for medium access control packet data unit (MAC PDU) includes a memory, a transceiver, and a processor coupled to the memory and the transceiver. The processor is configured to control the transceiver to transmit, to a user equipment, a radio resource allocation and be configured a MAC PDU associated with the radio resource allocation from the user equipment, wherein the MAC PDU comprises one or more MAC subPDUs, each MAC subPDU comprises a MAC subheader, wherein a transceiver control interface (TCI) state activation/deactivation for a UE-specific physical downlink shared channel (PDSCH) medium access control (MAC) control element (CE) is identified by the MAC PDU subheader with a logical channel identity (LCID), wherein the UE-specific PDSCH MAC CE has a variable size comprising following fields: a component carrier (CC) list ID, Ti, and R, where the Ti field indicates an activation/deactivation status of a TCI state with a TCI state ID, and the R field means a reserved bit.

In an eight aspect of the present disclosure, a method operable for medium access control packet data unit (MAC PDU) of a network node includes transmitting, to a user equipment, a radio resource allocation and being configured a MAC PDU associated with the radio resource allocation from the user equipment, wherein the MAC PDU comprises one or more MAC subPDUs, each MAC subPDU comprises a MAC subheader, wherein a transceiver control interface (TCI) state activation/deactivation for a UE-specific physical downlink shared channel (PDSCH) medium access control (MAC) control element (CE) is identified by the MAC PDU subheader with a logical channel identity (LCID), wherein the UE-specific PDSCH MAC CE has a variable size comprising following fields: a component carrier (CC) list ID, Ti, and R, where the Ti field indicates an activation/deactivation status of a TCI state with a TCI state ID, and the R field means a reserved bit.

In a ninth aspect of the present disclosure, a user equipment operable for medium access control packet data unit (MAC PDU) includes a memory, a transceiver, and a processor coupled to the memory and the transceiver. The processor is configured to control the transceiver to receive a radio resource allocation from a network node and configure a MAC PDU associated with the radio resource allocation, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit.

In a tenth aspect of the present disclosure, a method operable for medium access control packet data unit (MAC PDU) of a user equipment includes receiving a radio resource allocation from a network node and configuring a MAC PDU associated with the radio resource allocation, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit.

In an eleventh aspect of the present disclosure, a network node operable for medium access control packet data unit (MAC PDU) includes a memory, a transceiver, and a processor coupled to the memory and the transceiver. The processor is configured to control the transceiver to transmit, to a user equipment, a radio resource allocation and be configured a MAC PDU associated with the radio resource allocation from the user equipment, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit.

In a twelfth aspect of the present disclosure, a method operable for medium access control packet data unit (MAC PDU) of a network node includes transmitting, to a user equipment, a radio resource allocation and being configured a MAC PDU associated with the radio resource allocation from the user equipment, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit.

In a thirteenth aspect of the present disclosure, a non-transitory machine-readable storage medium has stored thereon instructions that, when executed by a computer, cause the computer to perform the above method.

In a fourteenth aspect of the present disclosure, a chip includes a processor, configured to call and run a computer program stored in a memory, to cause a device in which the chip is installed to execute the above method.

In a fifteenth aspect of the present disclosure, a computer readable storage medium, in which a computer program is stored, causes a computer to execute the above method.

In a sixteenth aspect of the present disclosure, a computer program product includes a computer program, and the computer program causes a computer to execute the above method.

In a seventeenth aspect of the present disclosure, a computer program causes a computer to execute the above method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a user equipment and a network node operable for medium access control packet data unit (MAC PDU) according to an embodiment of the present disclosure.

FIG. 2 is a flowchart illustrating a method operable for medium access control packet data unit (MAC PDU) of a user equipment according to an embodiment of the present disclosure.

FIG. 3 is a flowchart illustrating a method operable for medium access control packet data unit (MAC PDU) of a network node according to an embodiment of the present disclosure.

FIG. 4 is a flowchart illustrating a method operable for medium access control packet data unit (MAC PDU) of a user equipment according to another embodiment of the present disclosure.

FIG. 5 is a flowchart illustrating a method operable for medium access control packet data unit (MAC PDU) of a network node according to another embodiment of the present disclosure.

FIG. 6 is a flowchart illustrating a method operable for medium access control packet data unit (MAC PDU) of a user equipment according to still another embodiment of the present disclosure.

FIG. 7 is a flowchart illustrating a method operable for medium access control packet data unit (MAC PDU) of a network node according to still another embodiment of the present disclosure.

FIG. 8 is a schematic diagram of an exemplary illustration of a current physical uplink control channel (PUCCH) spatial relation activation/deactivation medium access control (MAC) control element (CE).

FIG. 9 is a schematic diagram of an exemplary illustration of a PUCCH spatial relation activation/deactivation MAC CE with single PUCCH group PUCCH spatial relation information (SRI) ID according to an embodiment of the present disclosure.

FIG. 10 is a schematic diagram of an exemplary illustration of a PUCCH spatial relation activation/deactivation MAC CE with single PUCCH group PUCCH spatial relation information (SRI) ID according to an embodiment of the present disclosure.

FIG. 11 is a schematic diagram of an exemplary illustration of a PUCCH spatial relation activation/deactivation MAC CE with single PUCCH group PUCCH spatial relation information (SRI) ID according to another embodiment of the present disclosure.

FIG. 12 is a schematic diagram of an exemplary illustration of a PUCCH spatial relation activation/deactivation MAC CE with single PUCCH group PUCCH spatial relation information (SRI) ID according to another embodiment of the present disclosure.

FIG. 13 is a schematic diagram of an exemplary illustration of a PUCCH spatial relation activation/deactivation MAC CE with multiple PUCCH group SRI (group ID) according to an embodiment of the present disclosure.

FIG. 14 is a schematic diagram of an exemplary illustration of a PUCCH spatial relation activation/deactivation MAC CE with multiple PUCCH group SRI (group ID) according to another embodiment of the present disclosure.

FIG. 15 is a schematic diagram of an exemplary illustration of a PUCCH spatial relation activation/deactivation MAC CE with multiple PUCCH group SRI (group ID) according to an embodiment of the present disclosure.

FIG. 16 is a schematic diagram of an exemplary illustration of a PUCCH spatial relation activation/deactivation MAC CE with multiple PUCCH group SRI (group ID) according to another embodiment of the present disclosure.

FIG. 17 is a schematic diagram of an exemplary illustration of a PUCCH spatial relation activation/deactivation MAC CE with multiple PUCCH group SRI (bitmap) according to an embodiment of the present disclosure.

FIG. 18 is a schematic diagram of an exemplary illustration of a PUCCH spatial relation activation/deactivation MAC CE with multiple PUCCH group SRI (bitmap) according to an embodiment of the present disclosure.

FIG. 19 is a schematic diagram of an exemplary illustration of a PUCCH spatial relation activation/deactivation MAC CE with multiple PUCCH group SRI (bitmap) according to another embodiment of the present disclosure.

FIG. 20 is a schematic diagram of an exemplary illustration of a PUCCH spatial relation activation/deactivation MAC CE with multiple PUCCH group SRI (bitmap) according to another embodiment of the present disclosure.

FIG. 21 is a schematic diagram of an exemplary illustration of a PUCCH spatial relation activation/deactivation MAC CE indicating corresponding SRI according to an embodiment of the present disclosure.

FIG. 22 is a schematic diagram of an exemplary illustration of a PUCCH spatial relation activation/deactivation MAC CE indicating corresponding SRI according to an embodiment of the present disclosure.

FIG. 23 is a schematic diagram of an exemplary illustration of a transceiver control interface (TCI) state activation/deactivation for a UE-specific physical downlink shared channel (PDSCH) MAC CE according to an embodiment of the present disclosure.

FIG. 24 is a schematic diagram of an exemplary illustration of a TCI state Indication for UE-specific physical downlink control channel (PDCCH) MAC CE according to an embodiment of the present disclosure.

FIG. 25 is a schematic diagram of an exemplary illustration of a TCI state Indication for UE-specific physical downlink control channel (PDCCH) MAC CE according to another embodiment of the present disclosure.

FIG. 26 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

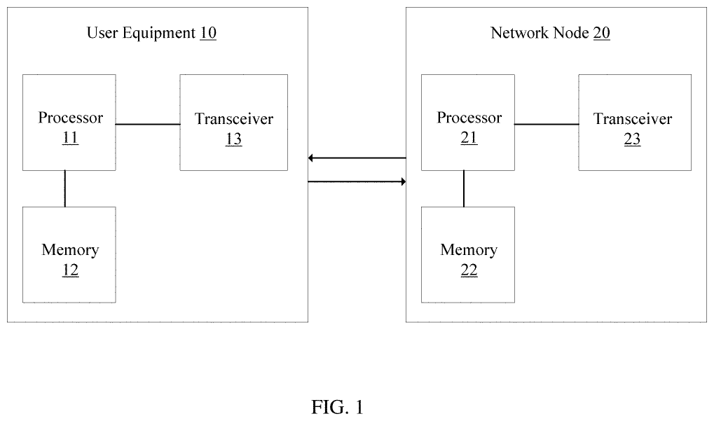

FIG. 1 illustrates that, in some embodiments, a user equipment (UE) 10 and a network node 20 such as a gNB operable for medium access control packet data unit (MAC PDU) according to an embodiment of the present disclosure are provided. For example, the MAC PDU is for MSGB. The UE 10 may include a processor 11, a memory 12, and a transceiver 13. The network node 20 may include a processor 21, a memory 22, and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal. The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via various means are known in the art.

In some embodiments, the processor 11 is configured to control the transceiver 13 to receive a radio resource allocation from the network node 20 and configure a MAC PDU associated with the radio resource allocation, wherein the MAC PDU comprises one or more MAC subPDUs, each MAC subPDU comprises a MAC subheader, wherein a physical uplink control channel (PUCCH) spatial relation activation/deactivation medium access control (MAC) control element (CE) is identified by the MAC PDU subheader with a logical channel identity (LCID), the PUCCH spatial relation activation/deactivation MAC CE includes following fields: a serving cell ID, a bandwidth part (BWP) ID, R, and at least one of one or multiple of PUCCH resource group (PRG) IDs and one or multiple of PUCCH spatial relation information (SRI) ID indexes, where the R field means a reserved bit. This can solve issues of the prior art, save signaling overhead, provide better communication, and/or improve reliability.

In some embodiments, the processor 21 is configured to control the transceiver 23 to transmit, to the user equipment 10, a radio resource allocation and be configured a MAC PDU associated with the radio resource allocation from the user equipment 10, wherein the MAC PDU comprises one or more MAC subPDUs, each MAC subPDU comprises a MAC subheader, wherein a physical uplink control channel (PUCCH) spatial relation activation/deactivation medium access control (MAC) control element (CE) is identified by the MAC PDU subheader with a logical channel identity (LCID), the PUCCH spatial relation activation/deactivation MAC CE includes following fields: a serving cell ID, a bandwidth part (BWP) ID, R, and at least one of one or multiple of PUCCH resource group (PRG) IDs and one or multiple of PUCCH spatial relation information (SRI) ID indexes, where the R field means a reserved bit. This can solve issues of the prior art, save signaling overhead, provide better communication, and/or improve reliability.

In some embodiments, each MAC subPDU comprises one of the following: a MAC subheader only (including padding), a MAC subheader and a MAC service data unit (SDU), a MAC subheader and a MAC CE, or a MAC subheader and a padding. In some embodiments, the PUCCH spatial relation activation/deactivation MAC CE has a fixed size of 16 bits or 24 bits or 80 bits and comprises the serving cell ID field, the BWP ID field, the R field, a single PRG ID field, and a single SRI index field. In some embodiments, the PUCCH spatial relation activation/deactivation MAC CE has a fixed size of 24 bits or 80 bits and comprises the serving cell ID field, the BWP ID field, the R field, a single PRG ID field, and a Si field, where the Si field indicates an activation status of PUCCH spatial relation information with a PUCCH-spatial relation information ID. In some embodiments, the PUCCH spatial relation activation/deactivation MAC CE comprises the serving cell ID field, the BWP ID field, the R field, multiple of PRG ID fields, and multiple of SRI index fields. In some embodiments, the PUCCH spatial relation activation/deactivation MAC CE has a fixed size of 24 bits or 40 bits or 48 bits and comprises the serving cell ID field, the BWP ID field, the R field, multiple of SRI index fields, and a Gi field. In some embodiments, the PUCCH spatial relation activation/deactivation MAC CE has a fixed size of 24 bits or 40 bits or has a variable size and comprises the serving cell ID field, the BWP ID field, the R field, and multiple of SRI index fields. In some embodiments, the serving cell ID field indicates an identity of a serving cell for which the PUCCH spatial relation activation/deactivation MAC CE applies, a length of the serving cell ID field is 5 bits. In some embodiments, the BWP ID field indicates an uplink (UL) BWP for which the PUCCH spatial relation activation/deactivation MAC CE applies as a codepoint of a downlink control information (DCI) BWP indicator field, and a length of the BWP ID field is 2 bits.

In some embodiments, the PRG ID field contains an identifier of a PRG ID, and a length of the PRG ID field is 2 bits. In some embodiments, the SRI index comprises a PUCCH spatial relation information ID for a PUCCH resource group, and a length of the SRI index field is 3 bits or 6 bits. In some embodiments, the R field is set to 0. In some embodiments, if there is the PUCCH spatial relation information with the PUCCH-spatial relation information ID, configured for an UL BWP indicated by BWP ID field, where the Si field indicates the activation status of the PUCCH spatial relation information with the PUCCH-spatial relation information ID, otherwise a MAC entity ignores the Si field. In some embodiments, if the Si field is set to 1, the Si field indicates that the PUCCH spatial relation information with the PUCCH-spatial relation information ID is to be activated. In some embodiments, if the Si field is set to 0, the Si field indicates that the PUCCH spatial relation information with the PUCCH-spatial relation information ID is to be deactivated. In some embodiments, only a single PUCCH spatial relation information is active for a PUCCH resource at a time. In some embodiments, the Gi field means a bitmap of a PRG index. In some embodiments, a number of the SRI index fields is five, one of the SRI index fields is 1 bit, one of the SRI index fields is 2 bits, and three of the SRI index fields are 3 bits. In some embodiments, a number of the SRI index fields is four, the four SRI index fields are 3 bits.

In some embodiments, the processor 11 is configured to control the transceiver 13 to receive a radio resource allocation from the network node 20 and configure a MAC PDU associated with the radio resource allocation, wherein the MAC PDU comprises one or more MAC subPDUs, each MAC subPDU comprises a MAC subheader, wherein a transceiver control interface (TCI) state activation/deactivation for a UE-specific physical downlink shared channel (PDSCH) medium access control (MAC) control element (CE) is identified by the MAC PDU subheader with a logical channel identity (LCID), wherein the UE-specific PDSCH MAC CE has a variable size comprising following fields: a component carrier (CC) list ID, Ti, and R, where the Ti field indicates an activation/deactivation status of a TCI state with a TCI state ID, and the R field means a reserved bit. This can solve issues of the prior art, save signaling overhead, provide better communication, and/or improve reliability. In some embodiments, the processor 21 is configured to control the transceiver 23 to transmit, to the user equipment 10, a radio resource allocation and be configured a MAC PDU associated with the radio resource allocation from the user equipment 10, wherein the MAC PDU comprises one or more MAC subPDUs, each MAC subPDU comprises a MAC subheader, wherein a transceiver control interface (TCI) state activation/deactivation for a UE-specific physical downlink shared channel (PDSCH) medium access control (MAC) control element (CE) is identified by the MAC PDU subheader with a logical channel identity (LCID), wherein the UE-specific PDSCH MAC CE has a variable size comprising following fields: a component carrier (CC) list ID, Ti, and R, where the Ti field indicates an activation/deactivation status of a TCI state with a TCI state ID, and the R field means a reserved bit. This can solve issues of the prior art, save signaling overhead, provide better communication, and/or improve reliability.

In some embodiments, each MAC subPDU comprises one of the following: a MAC subheader only (including padding), a MAC subheader and a MAC service data unit (SDU), a MAC subheader and a MAC CE, or a MAC subheader and a padding. In some embodiments, the CC list ID field indicates an identity of a CC for which the UE-specific PDSCH MAC CE applies, and a length of the CC list ID field is 1 bit. In some embodiments, if there is the TCI state with the TCI state ID, the Ti field indicates the activation/deactivation status of the TCI state with the TCI state ID, otherwise a MAC entity ignores the Ti field. In some embodiments, if the Ti field is set to 1, the Ti field indicates that the TCI state with the TCI state ID is to be activated and mapped to a codepoint of a downlink control information (DCI) transmission configuration indication field. In some embodiments, if the Ti field is set to 0, the Ti field indicates that the TCI state with the TCI state ID is to be deactivated and is not mapped to the codepoint of the DCI transmission configuration indication field. In some embodiments, the codepoint to which the TCI state is mapped is determined by an ordinal position thereof among all TCI states with the Ti field set to 1. In some embodiments, a first TCI state with the Ti field set to 1 is mapped to a codepoint value 0, and a second TCI state with the Ti field set to 1 is mapped to a codepoint value 1. In some embodiments, a maximum number of activated TCI states is 8. In some embodiments, the R field is set to 0.

In some embodiments, the processor 11 is configured to control the transceiver 13 to receive a radio resource allocation from the network node 20 and configure a MAC PDU associated with the radio resource allocation, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit. This can solve issues of the prior art, save signaling overhead, provide better communication, and/or improve reliability. In some embodiments, the processor 21 is configured to control the transceiver 23 to transmit, to the user equipment 10, a radio resource allocation and be configured a MAC PDU associated with the radio resource allocation from the user equipment 10, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit. This can solve issues of the prior art, save signaling overhead, provide better communication, and/or improve reliability.

In some embodiments, each MAC subPDU comprises one of the following: a MAC subheader only (including padding), a MAC subheader and a MAC service data unit (SDU), a MAC subheader and a MAC CE, or a MAC subheader and a padding. In some embodiments, the CC list ID field indicates an identity of a CC for which the UE-specific PDCCH MAC CE applies, and a length of the CC list ID field is 1 bit. In some embodiments, the coreset ID field indicates a control resource set identified with a control resource set ID, for which a TCI state is being indicated. In some embodiments, if a value of the coreset ID field is 0, the coreset ID field refers to a control resource set configured by a control resource set zero. In some embodiments, a length of the coreset ID field is 4 bits or 5 bits. In some embodiments, the TCI state ID field indicates a TCI state identified by a TCI state ID applicable to a control resource set identified by the coreset ID field. In some embodiments, if the TCI state ID field of a coreset ID is set to 0, the TCI state ID field indicates a TCI state ID for a TCI state of first 64 TCI states configured in a PDSCH configuration in an active bandwidth part (BWP). In some embodiments, if the TCI state ID field of the coreset ID is set to the other value than 0, the TCI state ID field indicates a TCI state ID configured in a control resource set identified by an indicated coreset ID. In some embodiments, a length of the TCI state ID field is 7 bits. In some embodiments, the R field is set to 0.

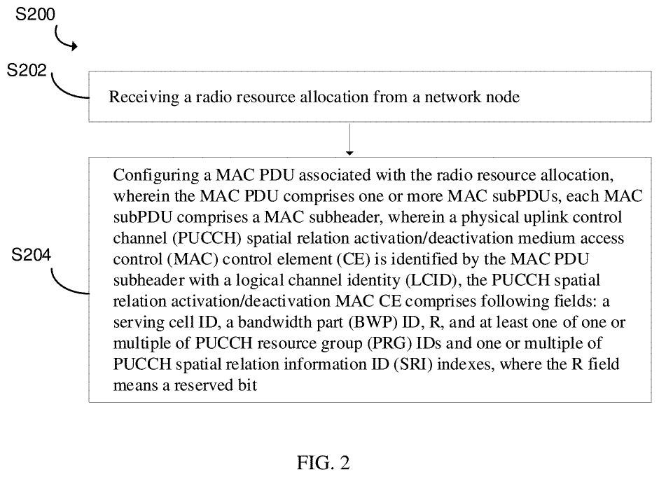

FIG. 2 illustrates a method S200 operable for medium access control packet data unit (MAC PDU) of a user equipment according to an embodiment of the present disclosure. In some embodiments, the method S200 includes: a block 202, receiving a radio resource allocation from a network node, and a block S204, configuring a MAC PDU associated with the radio resource allocation, wherein the MAC PDU comprises one or more MAC subPDUs, each MAC subPDU comprises a MAC subheader, wherein a physical uplink control channel (PUCCH) spatial relation activation/deactivation medium access control (MAC) control element (CE) is identified by the MAC PDU subheader with a logical channel identity (LCID), the PUCCH spatial relation activation/deactivation MAC CE includes following fields: a serving cell ID, a bandwidth part (BWP) ID, R, and at least one of one or multiple of PUCCH resource group (PRG) IDs and one or multiple of PUCCH spatial relation information (SRI) ID indexes, where the R field means a reserved bit. This can solve issues of the prior art, save signaling overhead, provide better communication, and/or improve reliability.

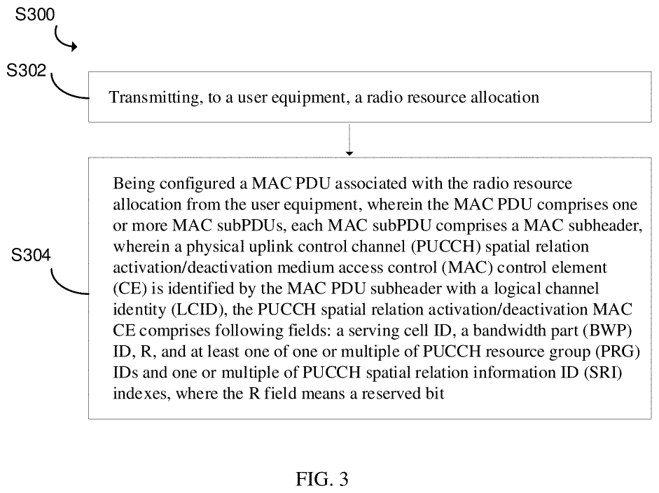

FIG. 3 illustrates a method S300 operable for medium access control packet data unit (MAC PDU) of a network node according to an embodiment of the present disclosure. In some embodiments, the method S300 includes: a block S302, transmitting, to a user equipment, a radio resource allocation, and a block S304, being configured a MAC PDU associated with the radio resource allocation from the user equipment, wherein the MAC PDU comprises one or more MAC subPDUs, each MAC subPDU comprises a MAC subheader, wherein a physical uplink control channel (PUCCH) spatial relation activation/deactivation medium access control (MAC) control element (CE) is identified by the MAC PDU subheader with a logical channel identity (LCID), the PUCCH spatial relation activation/deactivation MAC CE includes following fields: a serving cell ID, a bandwidth part (BWP) ID, R, and at least one of one or multiple of PUCCH resource group (PRG) IDs and one or multiple of PUCCH spatial relation information (SRI) ID indexes, where the R field means a reserved bit. This can solve issues of the prior art, save signaling overhead, provide better communication, and/or improve reliability.

In some embodiments, each MAC subPDU comprises one of the following: a MAC subheader only (including padding), a MAC subheader and a MAC service data unit (SDU), a MAC subheader and a MAC CE, or a MAC subheader and a padding. In some embodiments, the PUCCH spatial relation activation/deactivation MAC CE has a fixed size of 16 bits or 24 bits or 80 bits and comprises the serving cell ID field, the BWP ID field, the R field, a single PRG ID field, and a single SRI index field. In some embodiments, the PUCCH spatial relation activation/deactivation MAC CE has a fixed size of 24 bits or 80 bits and comprises the serving cell ID field, the BWP ID field, the R field, a single PRG ID field, and a Si field, where the Si field indicates an activation status of PUCCH spatial relation information with a PUCCH-spatial relation information ID. In some embodiments, the PUCCH spatial relation activation/deactivation MAC CE comprises the serving cell ID field, the BWP ID field, the R field, multiple of PRG ID fields, and multiple of SRI index fields. In some embodiments, the PUCCH spatial relation activation/deactivation MAC CE has a fixed size of 24 bits or 40 bits or 48 bits and comprises the serving cell ID field, the BWP ID field, the R field, multiple of SRI index fields, and a Gi field. In some embodiments, the PUCCH spatial relation activation/deactivation MAC CE has a fixed size of 24 bits or 40 bits or has a variable size and comprises the serving cell ID field, the BWP ID field, the R field, and multiple of SRI index fields. In some embodiments, the serving cell ID field indicates an identity of a serving cell for which the PUCCH spatial relation activation/deactivation MAC CE applies, a length of the serving cell ID field is 5 bits. In some embodiments, the BWP ID field indicates an uplink (UL) BWP for which the PUCCH spatial relation activation/deactivation MAC CE applies as a codepoint of a downlink control information (DCI) BWP indicator field, and a length of the BWP ID field is 2 bits.

In some embodiments, the PRG ID field contains an identifier of a PRG ID, and a length of the PRG ID field is 2 bits. In some embodiments, the SRI index comprises a PUCCH spatial relation information ID for a PUCCH resource group, and a length of the SRI index field is 3 bits or 6 bits. In some embodiments, the R field is set to 0. In some embodiments, if there is the PUCCH spatial relation information with the PUCCH-spatial relation information ID, configured for an UL BWP indicated by BWP ID field, where the Si field indicates the activation status of the PUCCH spatial relation information with the PUCCH-spatial relation information ID, otherwise a MAC entity ignores the Si field. In some embodiments, if the Si field is set to 1, the Si field indicates that the PUCCH spatial relation information with the PUCCH-spatial relation information ID is to be activated. In some embodiments, if the Si field is set to 0, the Si field indicates that the PUCCH spatial relation information with the PUCCH-spatial relation information ID is to be deactivated. In some embodiments, only a single PUCCH spatial relation information is active for a PUCCH resource at a time. In some embodiments, the Gi field means a bitmap of a PRG index. In some embodiments, a number of the SRI index fields is five, one of the SRI index fields is 1 bit, one of the SRI index fields is 2 bits, and three of the SRI index fields are 3 bits. In some embodiments, a number of the SRI index fields is four, the four SRI index fields are 3 bits.

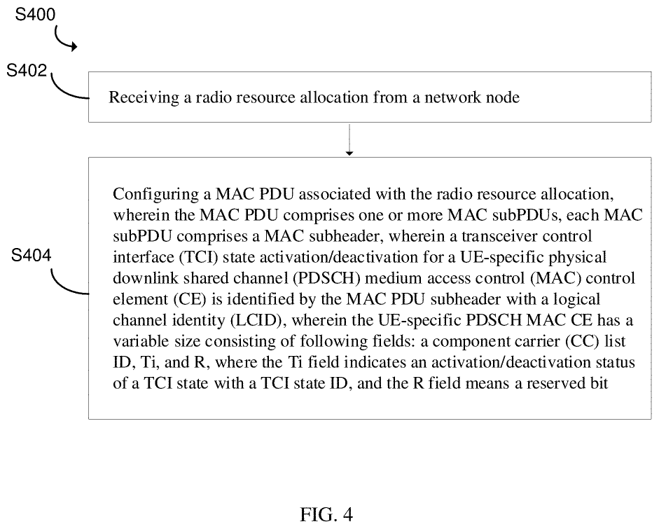

FIG. 4 illustrates a method S400 operable for medium access control packet data unit (MAC PDU) of a user equipment according to an embodiment of the present disclosure. In some embodiments, the method S400 includes: a block S402, receiving a radio resource allocation from a network node, and a block S404, configuring a MAC PDU associated with the radio resource allocation, wherein the MAC PDU comprises one or more MAC subPDUs, each MAC subPDU comprises a MAC subheader, wherein a transceiver control interface (TCI) state activation/deactivation for a UE-specific physical downlink shared channel (PDSCH) medium access control (MAC) control element (CE) is identified by the MAC PDU subheader with a logical channel identity (LCID), wherein the UE-specific PDSCH MAC CE has a variable size comprising following fields: a component carrier (CC) list ID, Ti, and R, where the Ti field indicates an activation/deactivation status of a TCI state with a TCI state ID, and the R field means a reserved bit. This can solve issues of the prior art, save signaling overhead, provide better communication, and/or improve reliability.

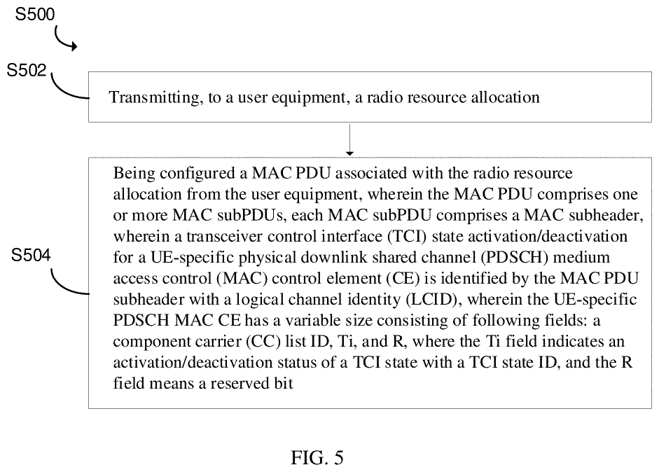

FIG. 5 illustrates a method S500 operable for medium access control packet data unit (MAC PDU) of a network node according to an embodiment of the present disclosure. In some embodiments, the method S500 includes: a block S502, transmitting, to a user equipment, a radio resource allocation, and a block S504, being configured a MAC PDU associated with the radio resource allocation from the user equipment, wherein the MAC PDU comprises one or more MAC subPDUs, each MAC subPDU comprises a MAC subheader, wherein a transceiver control interface (TCI) state activation/deactivation for a UE-specific physical downlink shared channel (PDSCH) medium access control (MAC) control element (CE) is identified by the MAC PDU subheader with a logical channel identity (LCID), wherein the UE-specific PDSCH MAC CE has a variable size comprising following fields: a component carrier (CC) list ID, Ti, and R, where the Ti field indicates an activation/deactivation status of a TCI state with a TCI state ID, and the R field means a reserved bit. This can solve issues of the prior art, save signaling overhead, provide better communication, and/or improve reliability.

In some embodiments, each MAC subPDU comprises one of the following: a MAC subheader only (including padding), a MAC subheader and a MAC service data unit (SDU), a MAC subheader and a MAC CE, or a MAC subheader and a padding. In some embodiments, the CC list ID field indicates an identity of a CC for which the UE-specific PDSCH MAC CE applies, and a length of the CC list ID field is 1 bit. In some embodiments, if there is the TCI state with the TCI state ID, the Ti field indicates the activation/deactivation status of the TCI state with the TCI state ID, otherwise a MAC entity ignores the Ti field. In some embodiments, if the Ti field is set to 1, the Ti field indicates that the TCI state with the TCI state ID is to be activated and mapped to a codepoint of a downlink control information (DCI) transmission configuration indication field. In some embodiments, if the Ti field is set to 0, the Ti field indicates that the TCI state with the TCI state ID is to be deactivated and is not mapped to the codepoint of the DCI transmission configuration indication field. In some embodiments, the codepoint to which the TCI state is mapped is determined by an ordinal position thereof among all TCI states with the Ti field set to 1. In some embodiments, a first TCI state with the Ti field set to 1 is mapped to a codepoint value 0, and a second TCI state with the Ti field set to 1 is mapped to a codepoint value 1. In some embodiments, a maximum number of activated TCI states is 8. In some embodiments, the R field is set to 0.

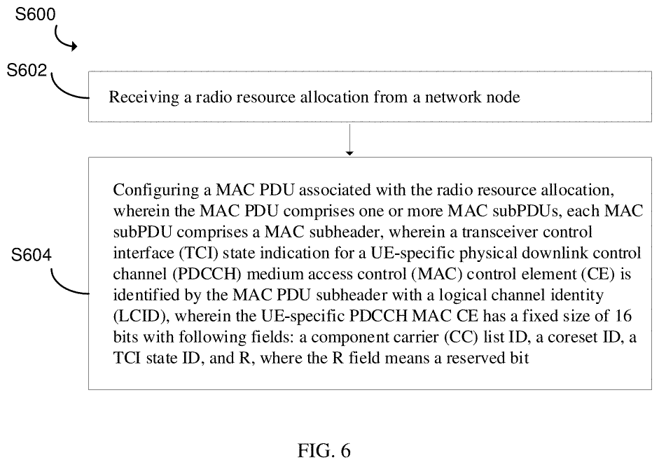

FIG. 6 illustrates a method S600 operable for medium access control packet data unit (MAC PDU) of a user equipment according to an embodiment of the present disclosure. In some embodiments, the method S600 includes: a block S602, receiving a radio resource allocation from a network node, and a block S604, configuring a MAC PDU associated with the radio resource allocation, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit. This can solve issues of the prior art, save signaling overhead, provide better communication, and/or improve reliability.

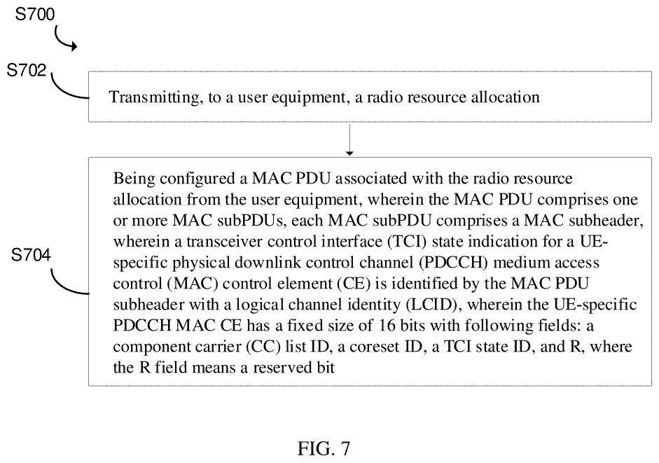

FIG. 7 illustrates a method S700 operable for medium access control packet data unit (MAC PDU) of a network node according to an embodiment of the present disclosure. In some embodiments, the method S700 includes: a block S702, transmitting, to a user equipment, a radio resource allocation, and a block S704, being configured a MAC PDU associated with the radio resource allocation from the user equipment, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit. This can solve issues of the prior art, save signaling overhead, provide better communication, and/or improve reliability.

In some embodiments, each MAC subPDU comprises one of the following: a MAC subheader only (including padding), a MAC subheader and a MAC service data unit (SDU), a MAC subheader and a MAC CE, or a MAC subheader and a padding. In some embodiments, the CC list ID field indicates an identity of a CC for which the UE-specific PDCCH MAC CE applies, and a length of the CC list ID field is 1 bit. In some embodiments, the coreset ID field indicates a control resource set identified with a control resource set ID, for which a TCI state is being indicated. In some embodiments, if a value of the coreset ID field is 0, the coreset ID field refers to a control resource set configured by a control resource set zero. In some embodiments, a length of the coreset ID field is 4 bits or 5 bits. In some embodiments, the TCI state ID field indicates a TCI state identified by a TCI state ID applicable to a control resource set identified by the coreset ID field. In some embodiments, if the TCI state ID field of a coreset ID is set to 0, the TCI state ID field indicates a TCI state ID for a TCI state of first 64 TCI states configured in a PDSCH configuration in an active bandwidth part (BWP). In some embodiments, if the TCI state ID field of the coreset ID is set to the other value than 0, the TCI state ID field indicates a TCI state ID configured in a control resource set identified by an indicated coreset ID. In some embodiments, a length of the TCI state ID field is 7 bits. In some embodiments, the R field is set to 0.

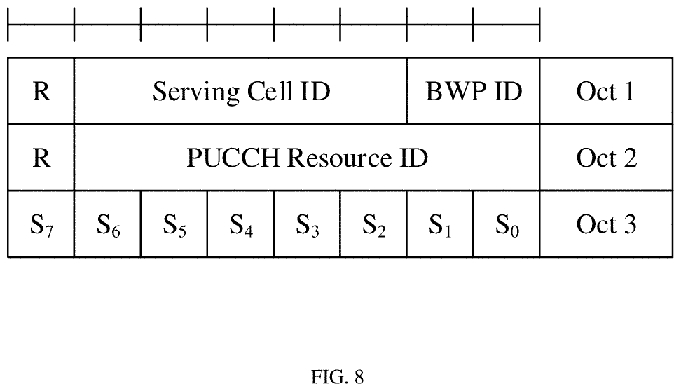

FIG. 8 is an exemplary illustration of a current physical uplink control channel (PUCCH) spatial relation activation/deactivation medium access control (MAC) control element (CE). FIG. 8 illustrates that, in some embodiments, a PUCCH spatial relation activation/deactivation MAC CE is identified by a MAC PDU subheader with LCID as specified in table 1. The PUCCH spatial relation activation/deactivation MAC CE has a fixed size of 24 bits with following fields: 1. A serving cell ID: the serving cell ID field indicates an identity of a serving cell for which the PUCCH spatial relation activation/deactivation MAC CE applies. A length of the serving cell ID is 5 bits. 2. A BWP ID: The BWP ID field indicates a UL BWP for which the PUCCH spatial relation activation/deactivation MAC CE applies as a codepoint of a DCI bandwidth part indicator field as specified in TS 38.212 [9]. A length of the BWP ID field is 2 bits. 3. A PUCCH resource ID: The PUCCH resource ID field contains an identifier of the PUCCH resource ID identified by PUCCH-Resourceld as specified in TS 38.331 [5]. A length of the PUCCH resource ID field is 7 bits. 4. Si: If there is a PUCCH spatial relation information with PUCCH-SpatialRelationlnfold i as specified in TS 38.331 [5], configured for an uplink bandwidth part indicated by the BWP ID field, Si indicates an activation status of the PUCCH spatial relation information with PUCCH-SpatialRelationlnfold i, otherwise a MAC entity ignores the Si field. The Si field is set to “1” to indicate the PUCCH spatial relation information with PUCCH-SpatialRelationlnfold i is activated. The Si field is set to “0” to indicate the PUCCH spatial relation information with the PUCCH-SpatialRelationlnfold i is deactivated. Only a single PUCCH spatial relation information can be active for a PUCCH resource at a time.

5. R: Reserved bit, set to “0”. The PUCCH spatial relation activation/deactivation MAC CE as illustrated has a large signaling overhead.

TABLE 1
Values of LCID for downlink shared channel (DL-SCH)

| | |
|---|---|
| 0 | CCCH |
| 1-32 | Identity of the logical channel |
| 33-46 | Reserved |
| 47 | Recommended bit rate |
| 48 | SP ZP CSI-RS Resource Set |
| | Activation/Deactivation |
| 49 | PUCCH spatial relation |
| | Activation/Deactivation |
| 50 | SP SRS Activation/Deactivation |
| 51 | SP CSI reporting on PUCCH |
| | Activation/Deactivation |
| 52 | TCI State Indication for UE-specific |
| | PDCCH |
| 53 | TCI States Activation/Deactivation for UEspecific PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

In some embodiments of the present disclosure, a new MAC CE format design is provided to allow a network node to configure SRI based on a PUCCH resource group, thereby saving signaling overhead. The following will be further explained with the drawings and examples.

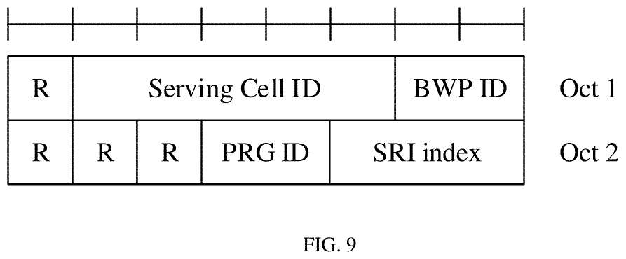

FIG. 9 is an exemplary illustration of a PUCCH spatial relation activation/deactivation MAC CE with single PUCCH group PUCCH spatial relation information (SRI) ID according to an embodiment of the present disclosure. FIG. 9 illustrates that, in some embodiments, a PUCCH spatial relation activation/deactivation MAC CE is identified by a MAC PDU subheader with LCID as specified in the Table 1. It has a fixed size of 16 bits with following fields:

Serving Cell ID: This field indicates the identity of the Serving Cell for which the MAC CE applies. The length of the field is 5 bits.

BWP ID: This field indicates a UL BWP for which the MAC CE applies as the codepoint of the DCI bandwidth part indicator field as specified in TS 38.212 [9]. The length of the BWP ID field is 2 bits.

PRG (PUCCH Resource group) ID: This field contains an identifier of the PUCCH resource group ID identified by PUCCH-Resourcegroupld as specified in TS 38.331 [5]. The length of the field is 2 bits.

SRI index: PUCCH Spatial Relation Info ID for a PUCCH resource group identified by PUCCH-SpatialRelationlnfold as specified in TS 38.331 [5]. The length of the field is 3 bits.

R: Reserved bit, set to “0”.

In addition, FIG. 9 illustrates that, in some embodiments, in an option, the MAC CE with single PUCCH group SRI is provided. That is the PUCCH spatial relation activation/deactivation MAC CE has a fixed size of 16 bits with following fields: the serving cell ID field, the BWP ID field, the R field, a single PRG ID field, and a single SRI index field. The length of the SRI index field is 3 bits. This can solve issues of the prior art, save signaling overhead, provide better communication, and/or improve reliability.

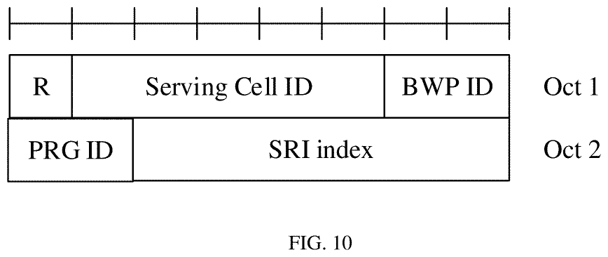

FIG. 10 is an exemplary illustration of a PUCCH spatial relation activation/deactivation MAC CE with single PUCCH group PUCCH spatial relation information (SRI) ID according to an embodiment of the present disclosure. In addition, FIG. 10 illustrates that, in some embodiments, in an option, the MAC CE with single PUCCH group SRI is provided. That is the PUCCH spatial relation activation/deactivation MAC CE has a fixed size of 16 bits with following fields: the serving cell ID field, the BWP ID field, the R field, a single PRG ID field, and a single SRI index field. The length of the SRI index field is 6 bits. This can solve issues of the prior art, save signaling overhead, provide better communication, and/or improve reliability.

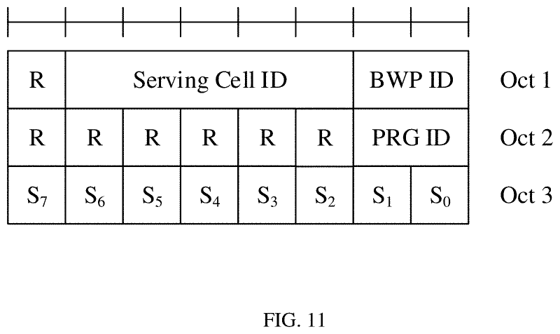

FIG. 11 is an exemplary illustration of a PUCCH spatial relation activation/deactivation MAC CE with single PUCCH group PUCCH spatial relation information (SRI) ID according to another embodiment of the present disclosure. FIG. 11 illustrates that, in some embodiments, in another option: the MAC CE with single PUCCH group SRI is provided. In some embodiments, the PUCCH spatial relation activation/deactivation MAC CE has a fixed size of 24 bits and comprises the serving cell ID field, the BWP ID field, the R field, a single PRG ID field, and a Si field. Si: If there is a PUCCH Spatial Relation Info with PUCCH-SpatialRelationlnfold i as specified in TS 38.331 [5], configured for the uplink bandwidth part indicated by BWP ID field, Si indicates the activation status of PUCCH Spatial Relation Info with PUCCH-SpatialRelationlnfold i, otherwise MAC entity ignores this field. The Si field is set to “1” to indicate PUCCH Spatial Relation Info with PUCCH-SpatialRelationlnfold i is activated. The Si field is set to “0” to indicate PUCCH Spatial Relation Info with PUCCH-SpatialRelationlnfold i is deactivated. Only a single PUCCH Spatial Relation Info can be active for a PUCCH Resource at a time. The length of the SRI index field is 3 bits. This can solve issues of the prior art, save signaling overhead, provide better communication, and/or improve reliability.

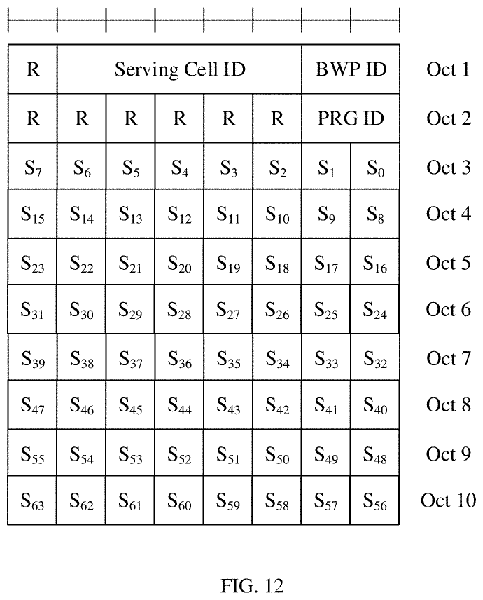

FIG. 12 is an exemplary illustration of a PUCCH spatial relation activation/deactivation MAC CE with single PUCCH group PUCCH spatial relation information (SRI) ID according to another embodiment of the present disclosure. FIG. 12 illustrates that, in some embodiments, in another option: the MAC CE with single PUCCH group SRI is provided. In some embodiments, the PUCCH spatial relation activation/deactivation MAC CE has a fixed size of 80 bits and comprises the serving cell ID field, the BWP ID field, the R field, a single PRG ID field, and a Si field. Si: If there is a PUCCH Spatial Relation Info with PUCCH-SpatialRelationlnfold i as specified in TS 38.331 [5], configured for the uplink bandwidth part indicated by BWP ID field, Si indicates the activation status of PUCCH Spatial Relation Info with PUCCH-SpatialRelationlnfold i, otherwise MAC entity ignores this field. The Si field is set to “1” to indicate PUCCH Spatial Relation Info with PUCCH-SpatialRelationlnfold i is activated. The Si field is set to “0” to indicate PUCCH Spatial Relation Info with PUCCH-SpatialRelationlnfold i is deactivated. Only a single PUCCH Spatial Relation Info can be active for a PUCCH Resource at a time. The length of the SRI index field is 6 bits. This can solve issues of the prior art, save signaling overhead, provide better communication, and/or improve reliability.

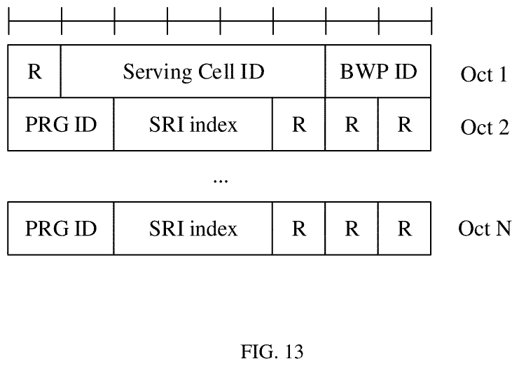

FIG. 13 is an exemplary illustration of a PUCCH spatial relation activation/deactivation MAC CE with multiple PUCCH group SRI (group ID) according to an embodiment of the present disclosure. FIG. 13 illustrates that, in some embodiments, the MAC CE with multiple PUCCH group SRI (group ID) is provided. In some embodiments, the PUCCH spatial relation activation/deactivation MAC CE has a variable size comprising following fields: the serving cell ID field, the BWP ID field, the R field, multiple of PRG ID fields, and multiple of SRI index fields. In some embodiments, the SRI index comprises a PUCCH spatial relation information ID for a PUCCH resource group, and a length of the SRI index field is 3 bits. A maximum number of the multiple PUCCH group SRI (group ID) is four. This can solve issues of the prior art, save signaling overhead, provide better communication, and/or improve reliability.

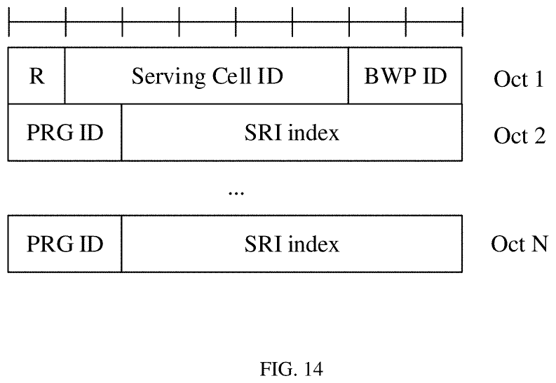

FIG. 14 is an exemplary illustration of a PUCCH spatial relation activation/deactivation MAC CE with multiple PUCCH group SRI (group ID) according to another embodiment of the present disclosure. FIG. 14 illustrates that, in some embodiments, the MAC CE with multiple PUCCH group SRI (group ID) is provided. In some embodiments, the PUCCH spatial relation activation/deactivation MAC CE has a variable size comprising following fields: the serving cell ID field, the BWP ID field, the R field, multiple of PRG ID fields, and multiple of SRI index fields. In some embodiments, the SRI index comprises a PUCCH spatial relation information ID for a PUCCH resource group, and a length of the SRI index field is 6 bits. A maximum number of the multiple PUCCH group SRI (group ID) is four. This can solve issues of the prior art, save signaling overhead, provide better communication, and/or improve reliability.

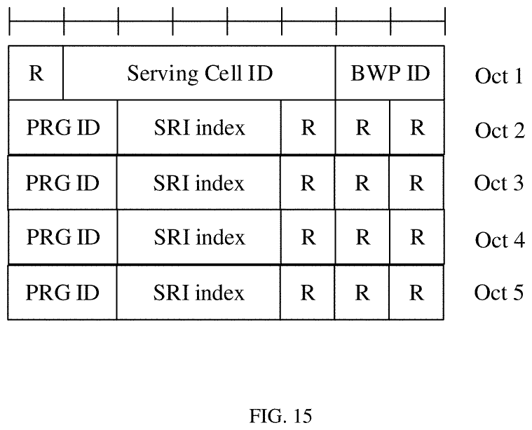

FIG. 15 is an exemplary illustration of a PUCCH spatial relation activation/deactivation MAC CE with multiple PUCCH group SRI (group ID) according to an embodiment of the present disclosure. FIG. 15 illustrates that, in some embodiments, the MAC CE with multiple PUCCH group SRI (group ID) is provided. In some embodiments, the PUCCH spatial relation activation/deactivation MAC CE has a fixed size of 40 bits comprising following fields: the serving cell ID field, the BWP ID field, the R field, multiple of PRG ID fields, and multiple of SRI index fields. In some embodiments, the SRI index comprises a PUCCH spatial relation information ID for a PUCCH resource group, and a length of the SRI index field is 3 bits. A number of the multiple PUCCH group SRI (group ID) is four. This can solve issues of the prior art, save signaling overhead, provide better communication, and/or improve reliability.

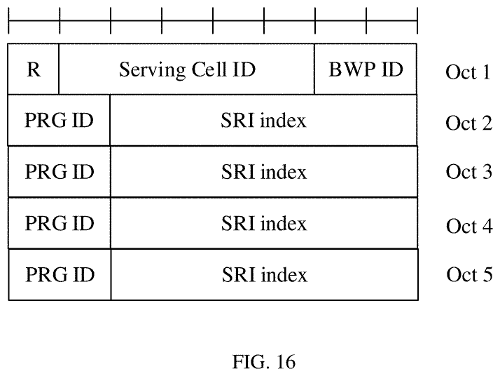

FIG. 16 is an exemplary illustration of a PUCCH spatial relation activation/deactivation MAC CE with multiple PUCCH group SRI (group ID) according to another embodiment of the present disclosure. FIG. 16 illustrates that, in some embodiments, the MAC CE with multiple PUCCH group SRI (group ID) is provided. In some embodiments, the PUCCH spatial relation activation/deactivation MAC CE has a fixed size of 40 bits comprising following fields: the serving cell ID field, the BWP ID field, the R field, multiple of PRG ID fields, and multiple of SRI index fields. In some embodiments, the SRI index comprises a PUCCH spatial relation information ID for a PUCCH resource group, and a length of the SRI index field is 6 bits. A number of the multiple PUCCH group SRI (group ID) is four. This can solve issues of the prior art, save signaling overhead, provide better communication, and/or improve reliability.

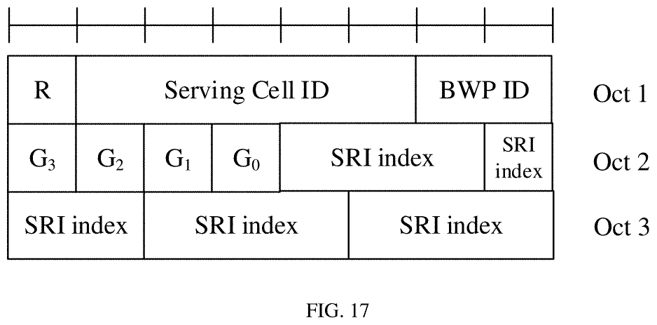

FIG. 17 is an exemplary illustration of a PUCCH spatial relation activation/deactivation MAC CE with multiple PUCCH group SRI (bitmap) according to an embodiment of the present disclosure. FIG. 17 illustrates that, in some embodiments, in an option: the MAC CE with multiple PUCCH group SRI (bitmap) is provided. In some embodiments, the PUCCH spatial relation activation/deactivation MAC CE has a fixed size of 24 bits and comprises the serving cell ID field, the BWP ID field, the R field, multiple of SRI index fields, and a Gi field. Gi: bitmap of PUCCH resource group index. In some embodiments, a number of the SRI index fields is five, one of the SRI index fields is 1 bit, one of the SRI index fields is 2 bits, and three of the SRI index fields are 3 bits. This can solve issues of the prior art, save signaling overhead, provide better communication, and/or improve reliability.

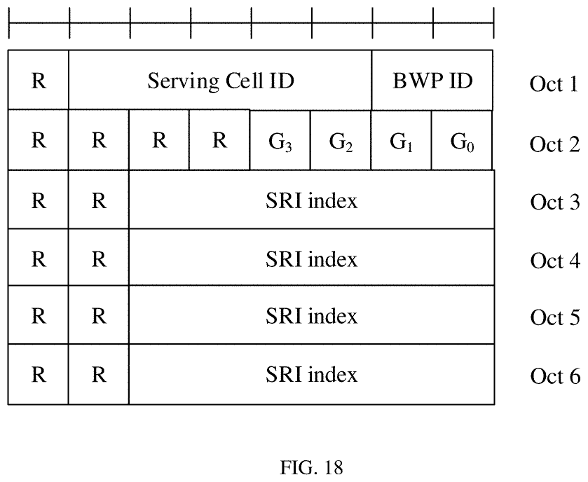

FIG. 18 is an exemplary illustration of a PUCCH spatial relation activation/deactivation MAC CE with multiple PUCCH group SRI (bitmap) according to an embodiment of the present disclosure. FIG. 18 illustrates that, in some embodiments, in an option: the MAC CE with multiple PUCCH group SRI (bitmap) is provided. In some embodiments, the PUCCH spatial relation activation/deactivation MAC CE has a fixed size of 48 bits and comprises the serving cell ID field, the BWP ID field, the R field, multiple of SRI index fields, and a Gi field. Gi: bitmap of PUCCH resource group index. In some embodiments, the length of the SRI index field is 6 bits. This can solve issues of the prior art, save signaling overhead, provide better communication, and/or improve reliability.

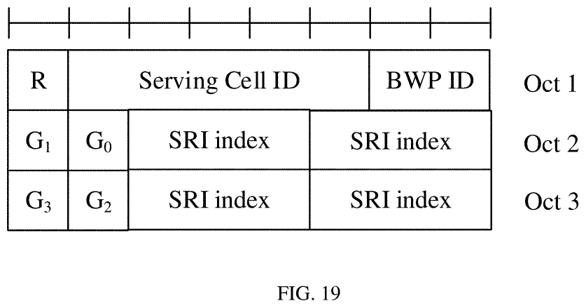

FIG. 19 is an exemplary illustration of a PUCCH spatial relation activation/deactivation MAC CE with multiple PUCCH group SRI (bitmap) according to another embodiment of the present disclosure. FIG. 19 illustrates that, in some embodiments, in another option: the MAC CE with multiple PUCCH group SRI (bitmap) is provided. In some embodiments, the PUCCH spatial relation activation/deactivation MAC CE has a fixed size of 24 bits and comprises the serving cell ID field, the BWP ID field, the R field, multiple of SRI index fields, and a Gi field. Gi: bitmap of PUCCH resource group index. In some embodiments, a number of the SRI index fields is four, the four SRI index fields are 3 bits. This can solve issues of the prior art, save signaling overhead, provide better communication, and/or improve reliability.

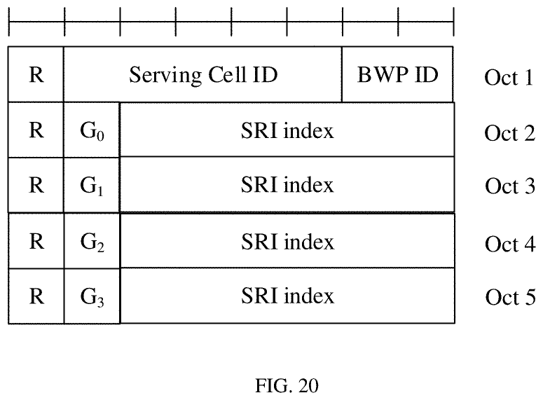

FIG. 20 is an exemplary illustration of a PUCCH spatial relation activation/deactivation MAC CE with multiple PUCCH group SRI (bitmap) according to another embodiment of the present disclosure. FIG. 20 illustrates that, in some embodiments, in another option: the MAC CE with multiple PUCCH group SRI (bitmap) is provided. In some embodiments, the PUCCH spatial relation activation/deactivation MAC CE has a fixed size of 40 bits and comprises the serving cell ID field, the BWP ID field, the R field, multiple of SRI index fields, and a Gi field. Gi: bitmap of PUCCH resource group index. In some embodiments, a number of the SRI index fields is four, the four SRI index fields are 6 bits. This can solve issues of the prior art, save signaling overhead, provide better communication, and/or improve reliability.

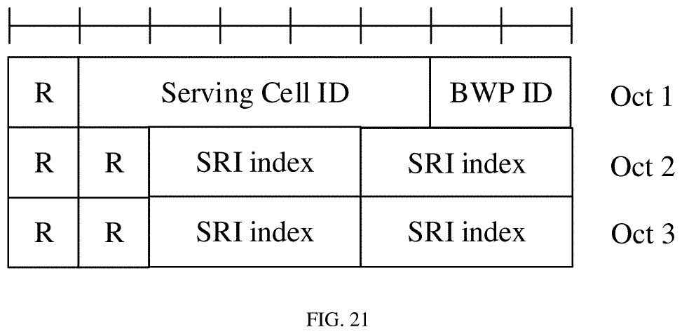

FIG. 21 is an exemplary illustration of a PUCCH spatial relation activation/deactivation MAC CE indicating corresponding SRI according to an embodiment of the present disclosure. FIG. 21 illustrates that, in some embodiments, in an option: an RRC indicates a group ID, and the MAC CE indicates corresponding SRI. In some embodiments, the PUCCH spatial relation activation/deactivation MAC CE has a fixed size of 24 bits and comprises the serving cell ID field, the BWP ID field, the R field, and multiple of SRI index fields. In some embodiments, a number of the SRI index fields is four, the four SRI index fields are 3 bits. This can solve issues of the prior art, save signaling overhead, provide better communication, and/or improve reliability.

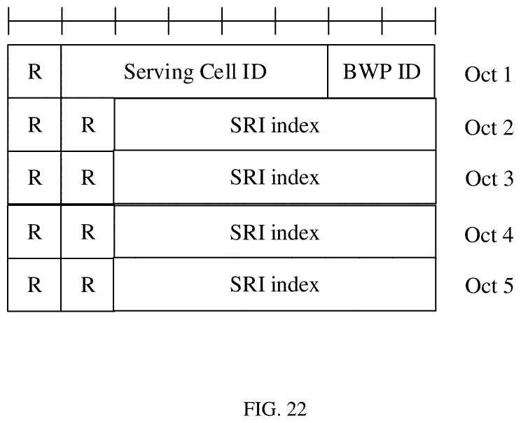

FIG. 22 is an exemplary illustration of a PUCCH spatial relation activation/deactivation MAC CE indicating corresponding SRI according to an embodiment of the present disclosure. FIG. 22 illustrates that, in some embodiments, in an option: an RRC indicates a group ID, and the MAC CE indicates corresponding SRI. In some embodiments, the PUCCH spatial relation activation/deactivation MAC CE has a fixed size of 40 bits and comprises the serving cell ID field, the BWP ID field, the R field, and multiple of SRI index fields. In some embodiments, a number of the SRI index fields is four, the four SRI index fields are 6 bits. This can solve issues of the prior art, save signaling overhead, provide better communication, and/or improve reliability.

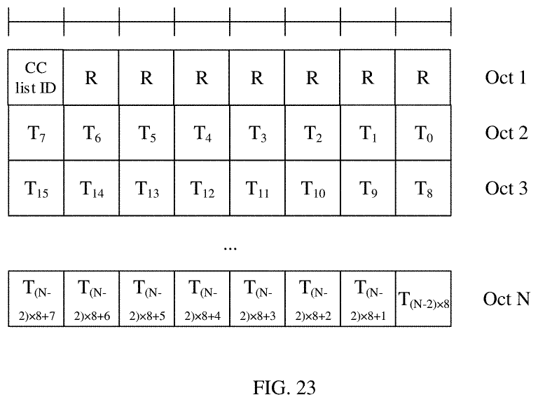

FIG. 23 is an exemplary illustration of a transceiver control interface (TCI) state activation/deactivation for a UE-specific physical downlink shared channel (PDSCH) MAC CE according to an embodiment of the present disclosure. FIG. 23 illustrates that, in some embodiments, a TCI states activation/deactivation for UE-specific PDSCH MAC CE is identified by a MAC PDU subheader with LCID as specified in the Table 1. It has a variable size comprising following fields:

CC list ID: This field indicates the identity of the CC for which the MAC CE applies. The length of the field is 1 bit.

Ti: If there is a TCI state with TCI-Stateld i as specified in TS 38.331 [5], this field indicates the activation/deactivation status of the TCI state with TCI-Stateld i, otherwise MAC entity ignores the Ti field. The Ti field is set to “1” to indicate that the TCI state with TCI-Stateld i shall be activated and mapped to the codepoint of the DCI Transmission Configuration Indication field, as specified in TS 38.214 [7]. The Ti field is set to “0” to indicate that the TCI state with TCI-Stateld i is deactivated and is not mapped to the codepoint of the DCI Transmission Configuration Indication field. The codepoint to which the TCI State is mapped is determined by its ordinal position among all the TCI States with Ti field set to “1”, i.e. a first TCI State with Ti field set to “1” is mapped to the codepoint value 0, a second TCI State with Ti field set to “1” is mapped to the codepoint value 1 and so on. The maximum number of activated TCI states is 8.

R: Reserved bit, set to “0”. The UE-specific PDSCH MAC CE as illustrated in FIG. 23 can solve issues of the prior art, save signaling overhead, provide better communication, and/or improve reliability.

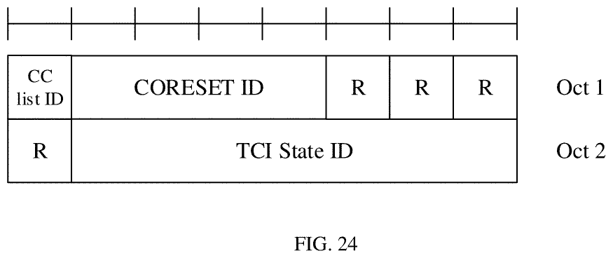

FIG. 24 is an exemplary illustration of a TCI state Indication for UE-specific physical downlink control channel (PDCCH) MAC CE according to an embodiment of the present disclosure. FIG. 24 illustrates that, in some embodiments, a TCI State Indication for UE-specific PDCCH MAC CE is identified by a MAC PDU subheader with LCID as specified in the Table 1. It has a fixed size of 16 bits with following fields:

CC list ID: This field indicates the identity of the CC list for which the MAC CE applies. The length of the field is 1 bit.

CORESET ID: This field indicates a Control Resource Set identified with ControlResourceSetld as specified in TS 38.331 [5], for which the TCI State is being indicated. In case the value of the field is 0, the field refers to the Control Resource Set configured by controlResourceSetZero as specified in TS 38.331 [5]. The length of the field is 4 bits.

TCI State ID: This field indicates the TCI state identified by TCI-Stateld as specified in TS 38.331 [5] applicable to the Control Resource Set identified by CORESET ID field. If the field of CORESET ID is set to 0, this field indicates a TCI-Stateld for a TCI state of the first 64 TCI-states configured by tci-States-ToAddModList and tci-States-ToReleaseList in the PDSCH-Config in the active BWP. If the field of CORESET ID is set to the other value than 0, this field indicates a TCI-Stateld configured by tci-StatesPDCCH-ToAddList and tci-StatesPDCCH-ToReleaseList in the controlResourceSet identified by the indicated CORESET ID. The length of the field is 7 bits. The UE-specific PDCCH MAC CE as illustrated in FIG. 24 can solve issues of the prior art, save signaling overhead, provide better communication, and/or improve reliability.

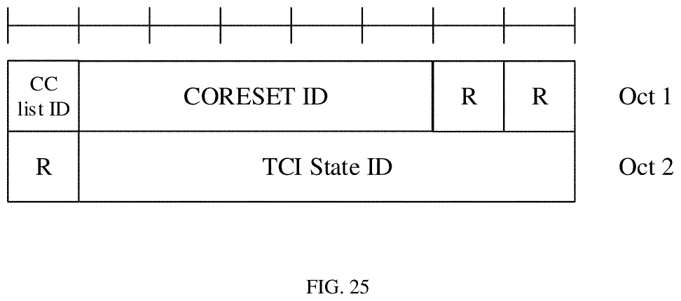

FIG. 25 is an exemplary illustration of a TCI state Indication for UE-specific physical downlink control channel (PDCCH) MAC CE according to another embodiment of the present disclosure. FIG. 25 illustrates that, in some embodiments, a TCI State Indication for UE-specific PDCCH MAC CE is identified by a MAC PDU subheader with LCID as specified in the Table 1. It has a fixed size of 16 bits with following fields: CC list ID: This field indicates the identity of the CC list for which the MAC CE applies. The length of the field is 1 bit. CORESET ID: This field indicates a Control Resource Set identified with ControlResourceSetld as specified in TS 38.331 [5], for which the TCI State is being indicated. In case the value of the field is 0, the field refers to the Control Resource Set configured by controlResourceSetZero as specified in TS 38.331 [5]. The length of the field is 5 bits. TCI State ID: This field indicates the TCI state identified by TCI-Stateld as specified in TS 38.331 [5] applicable to the Control Resource Set identified by CORESET ID field. If the field of CORESET ID is set to 0, this field indicates a TCI-Stateld for a TCI state of the first 64 TCI-states configured by tci-States-ToAddModList and tci-States-ToReleaseList in the PDSCH-Config in the active BWP. If the field of CORESET ID is set to the other value than 0, this field indicates a TCI-Stateld configured by tci-StatesPDCCH-ToAddList and tci-StatesPDCCH-ToReleaseList in the controlResourceSet identified by the indicated CORESET ID. The length of the field is 7 bits. The UE-specific PDCCH MAC CE as illustrated in FIG. 25 can solve issues of the prior art, save signaling overhead, provide better communication, and/or improve reliability.

In summary, in some embodiments of the present disclosure, a new MAC CE format design is provided to allow a network node to configure SRI based on a PUCCH resource group, thereby saving signaling overhead. Commercial interests for some embodiments are as follows. 1. Solving issues of the prior art, saving signaling overhead, providing better communication, and/or improving reliability. 2. Some embodiments of the present disclosure are used by 5G-NR chipset vendors, communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product.

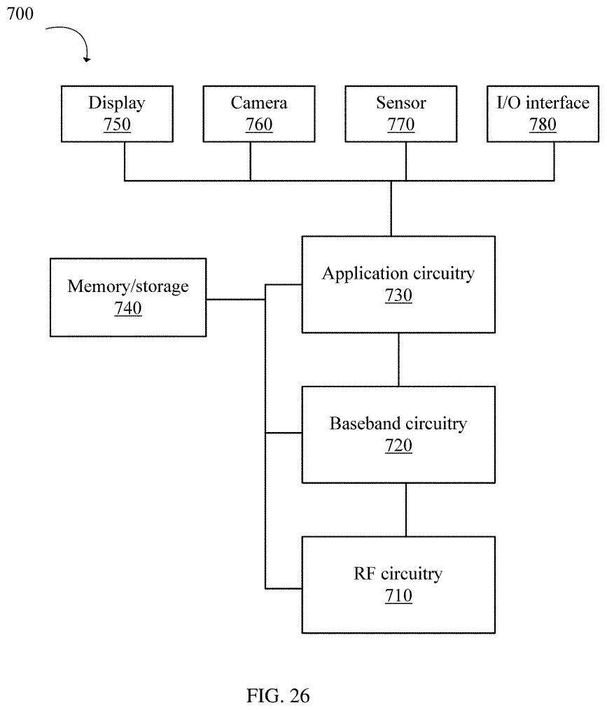

FIG. 26 is a block diagram of an example system 700 for wireless communication according to an embodiment of the present disclosure. Embodiments described herein may be implemented into the system using any suitably configured hardware and/or software. FIG. 26 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method operable for medium access control packet data unit (MAC PDU) of a user equipment (UE), comprising:
receiving a radio resource allocation from a network node; and
configuring a MAC PDU associated with the radio resource allocation, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit.

2. The method of claim 1, wherein the coreset ID field indicates a control resource set identified with a control resource set ID, for which a TCI state is being indicated.

3. The method of claim 2, wherein if a value of the coreset ID field is 0, the coreset ID field refers to a control resource set configured by a control resource set zero.

4. The method of claim 1, wherein a length of the coreset ID field is 4 bits or 5 bits.

5. The method of claim 1, wherein the TCI state ID field indicates a TCI state identified by a TCI state ID applicable to a control resource set identified by the coreset ID field.

6. The method of claim 5, wherein if the TCI state ID field of a coreset ID is set to 0, the TCI state ID field indicates a TCI state ID for a TCI state of first 64 TCI states configured in a PDSCH configuration in an active bandwidth part (BWP).

7. The method of claim 6, wherein if the TCI state ID field of the coreset ID is set to the other value than 0, the TCI state ID field indicates a TCI state ID configured in a control resource set identified by an indicated coreset ID.

8. A user equipment operable for medium access control packet data unit (MAC PDU), comprising:
a memory;
a transceiver; and
a processor coupled to the memory and the transceiver;
wherein the processor is configured to:
control the transceiver to receive a radio resource allocation from a network node; and
configure a MAC PDU associated with the radio resource allocation, wherein the MAC PDU comprises one or more MAC subPDUs, each MAC subPDU comprises a MAC subheader, wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit.

9. The user equipment of claim 8, wherein the coreset ID field indicates a control resource set identified with a control resource set ID, for which a TCI state is being indicated.

10. The user equipment of claim 9, wherein if a value of the coreset ID field is 0, the coreset ID field refers to a control resource set configured by a control resource set zero.

11. The user equipment of claim 8, wherein a length of the coreset ID field is 4 bits or 5 bits.

12. The user equipment of claim 8, wherein the TCI state ID field indicates a TCI state identified by a TCI state ID applicable to a control resource set identified by the coreset ID field.

13. The user equipment of claim 12, wherein if the TCI state ID field of a coreset ID is set to 0, the TCI state ID field indicates a TCI state ID for a TCI state of first 64 TCI states configured in a PDSCH configuration in an active bandwidth part (BWP).

14. The user equipment of claim 13, wherein if the TCI state ID field of the coreset ID is set to the other value than 0, the TCI state ID field indicates a TCI state ID configured in a control resource set identified by an indicated coreset ID.

15. A network node operable for medium access control packet data unit (MAC PDU), comprising:
a memory;
a transceiver; and
a processor coupled to the memory and the transceiver;
wherein the processor is configured to:
control the transceiver to transmit, to a user equipment, a radio resource allocation; and
be configured a MAC PDU associated with the radio resource allocation from the user equipment, wherein the MAC PDU comprises one or more MAC subPDUs, each MAC subPDU comprises a MAC subheader, wherein the MAC PDU comprises a MAC PDU subheader with a logical channel identity (LCID), wherein a transceiver control interface (TCI) state indication for a UE-specific physical downlink control channel (PDCCH) medium access control (MAC) control element (CE) is identified by the MAC PDU subheader with a logical channel identity (LCID), wherein the UE-specific PDCCH MAC CE has a fixed size of 16 bits with following fields: a component carrier (CC) list ID, a coreset ID, a TCI state ID, and R, where the R field means a reserved bit.

16. The network node of claim 15, wherein the coreset ID field indicates a control resource set identified with a control resource set ID, for which a TCI state is being indicated.

17. The network node of claim 16, wherein if a value of the coreset ID field is 0, the coreset ID field refers to a control resource set configured by a control resource set zero.

18. The network node of claim 15, wherein the TCI state ID field indicates a TCI state identified by a TCI state ID applicable to a control resource set identified by the coreset ID field.

19. The network node of claim 18, wherein if the TCI state ID field of a coreset ID is set to 0, the TCI state ID field indicates a TCI state ID for a TCI state of first 64 TCI states configured in a PDSCH configuration in an active bandwidth part (BWP).

20. The network node of claim 19, wherein if the TCI state ID field of the coreset ID is set to the other value than 0, the TCI state ID field indicates a TCI state ID configured in a control resource set identified by an indicated coreset ID.
